(19) United States
(12) Patent Application Publication
(10) Pub. No.: US 2026/0078953 A1
(43) Pub. Date: Mar. 19, 2026

(54) FACILITY AND METHOD FOR MANUFACTURING ELECTRODES

(71) Applicant: SK ON CO., LTD., Seoul (KR)

(72) Inventors: Chang Mook HWANG, Daejeon (KR); Na Eun GIL, Daejeon (KR); Min Cheol KIM, Daejeon (KR); Hyun Ji KIM, Daejeon (KR); Jong Hyeok LEE, Daejeon (KR); Yoon Ji JO, Daejeon (KR)

(21) Appl. No.: 19/312,326

(22) Filed: Aug. 28, 2025

(30) Foreign Application Priority Data
Sep. 13, 2024 (KR) 10-2024-0125661

(51) Int. Cl. F26B 13/18; F26B 3/30; H01B 13/00; H01M 4/04

(52) U.S. Cl. CPC F26B 13/183; H01B 13/0016; H01M 4/0471; F26B 3/30

(57) ABSTRACT

A facility and method for manufacturing electrodes are disclosed. The facility for manufacturing electrodes according to an embodiment of the present disclosure may include a first chamber and a second chamber, each of which has a hollow portion formed therein and arranged side by side; an electric field unit, at least a portion of which is located inside the first chamber and configured to generate an electric field; and a heater unit, at least a portion of which is located inside the second chamber.

### CROSS-REFERENCE TO RELATED APPLICATION

This patent application claims the priority and benefits of Korean patent application No. 10-2024-0125661, filed on Sep. 13, 2024, the disclosure of which is incorporated herein by reference in its entirety.

### BACKGROUND OF THE INVENTION

### 1. Field of the Invention

The present disclosure relates to a facility and method for manufacturing electrodes.

### 2. Description of the Related Art

Electrodes used in a secondary battery may include an electrode foil and a coating layer applied to the electrode foil. The coating layer may include an active material and a binder. During drying of the electrodes, a phase change may occur in the binder included in the electrodes.

For example, during heating of the electrodes, the alpha phase fraction of the binder included in the electrodes may decrease, and the gamma phase fraction may increase. In this case, the characteristics of the secondary battery may deteriorate due to the change in the physical properties of the binder.

### SUMMARY OF THE INVENTION

An object of the present disclosure is to provide a facility and method for manufacturing electrodes that may improve the cycle life of a battery cell.

A facility for drying electrodes according to the present disclosure may include: a first chamber and a second chamber, each defining a hollow portion therein and arranged side by side; an electric field unit, at least a portion of which is located inside the first chamber and configured to generate an electric field; and a heater unit, at least a portion of which is located inside the second chamber.

An internal pressure of the first chamber may be greater than that of the second chamber, and an internal temperature of the second chamber may be higher than that of the first chamber.

The electric field unit may include: a positive potential plate and a negative potential plate spaced apart while facing each other; and a voltage source that electrically connects the positive potential plate and the negative potential plate.

A potential of the positive potential plate may be higher than that of the negative potential plate.

The facility for drying electrodes may further include: a pre-chamber defining a hollow portion therein and disposed adjacent to the first chamber; and a post-chamber defining a hollow portion therein and disposed adjacent to the second chamber, wherein the pre-chamber, the first chamber, the second chamber and the post-chamber may be arranged in sequence.

The internal pressures of the pre-chamber and the post-chamber may be greater than those of the first chamber and the second chamber, and the internal temperature of the pre-chamber and the post-chamber may be lower than those of the first chamber and the second chamber.

The intensity of the electric field may be 5 [mV/m] to 20 [mV/m].

A facility for drying electrodes according to the present disclosure may include: a first chamber defining a hollow portion therein and through which the electrode is introduced and discharged; a second chamber defining a hollow portion therein and into which the electrode discharged from the first chamber is introduced; an electric field unit, at least a portion of which is located inside the first chamber and configured to apply an electric field to the electrode; and a heater unit, at least a portion of which is located inside the second chamber and configured to apply heat to the electrode.

An internal pressure of the first chamber may be greater than that of the second chamber, and an internal temperature of the second chamber may be higher than that of the first chamber.

The electric field unit may include: a positive potential plate facing one side of the electrode; and a negative potential plate facing the opposite side of the electrode, wherein a potential of the positive potential plate may be higher than that of the negative potential plate.

The facility for drying electrodes may further include: a pre-chamber defining a hollow portion therein and disposed adjacent to the first chamber; and a post-chamber defining a hollow portion therein and disposed adjacent to the second chamber, wherein the pre-chamber, the first chamber, the second chamber and the post-chamber may be arranged in sequence.

The electrode may be introduced into the pre-chamber and discharged from the pre-chamber, the electrode discharged from the pre-chamber may be introduced into the first chamber, the electrode discharged from the first chamber may be introduced into the second chamber, and the electrode discharged from the second chamber may be introduced into the post-chamber.

The internal pressures of the pre-chamber and the post-chamber may be greater than those of the first chamber and the second chamber, and the internal temperatures of the pre-chamber and the post-chamber may be lower than those of the first chamber and the second chamber.

A method for manufacturing electrodes according to the present disclosure may include the steps of: applying an electric field to the electrode; heating the electrode; and notching the electrode.

The step of applying an electric field to the electrode may include: applying an electric field having a first electric field intensity to the electrode; and applying an electric field having a second electric field intensity to the electrode.

The second electric field intensity may be greater than the first electric field intensity.

The first electric field intensity may be 5 [mV/m] to 10 [mV/m], and the second electric field intensity may be 15 [mV/m] to 20 [mV/m].

In the step of applying an electric field to the electrode, the electrode may be positioned in transit through a first chamber, and in the step of heating the electrode, the electrode may be positioned in transit through a second chamber, wherein an internal pressure of the first chamber may be greater than that of the second chamber, and an internal temperature of the second chamber may be higher than that of the first chamber.

In the step of applying an electric field to the electrode, the intensity of the electric field applied to the electrode may be 5 [mV/m] to 20 [mV/m].

According to an embodiment of the present disclosure, a facility and method for manufacturing electrodes that improve the cycle life of a battery cell may be provided.

The facility and method for manufacturing electrodes of the present disclosure may be widely applied in green technology fields, such as electric vehicles, battery charging stations, as well as solar power generation, wind power generation, and the like, which use the batteries.

The facility and method for manufacturing electrodes of the present disclosure may be used in eco-friendly electric vehicles, hybrid vehicles, and the like, which are aimed at mitigating climate change by reducing air pollution and greenhouse gas emissions.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view illustrating a chamber unit according to an embodiment of the present disclosure;

FIG. 2 is a view illustrating an electrode being introduced into a facility for drying electrodes (hereinafter, referred to as an “electrode drying facility”);

FIG. 3 is a view illustrating an electrode drying facility according to an embodiment of the present disclosure;

FIG. 4 is a cross-sectional view of the electrode drying facility shown in FIG. 3, taken along line A1-A2;

FIG. 5 is a view illustrating a heater unit shown in FIG. 4;

FIG. 6 is a view schematically illustrating an electric field unit shown in FIG. 4;

FIG. 7 is a block diagram of the electrode drying facility according to an embodiment of the present disclosure;

FIG. 8 is a table illustrating examples having different internal settings and process sequences of a plurality of chamber units;

FIG. 9 is a table illustrating the characteristics of electrodes and battery cells manufactured according to each example shown in FIG. 8; and

FIG. 10 is a flowchart illustrating a method for manufacturing electrodes according to an embodiment of the present disclosure.

### DETAILED DESCRIPTION OF THE INVENTION

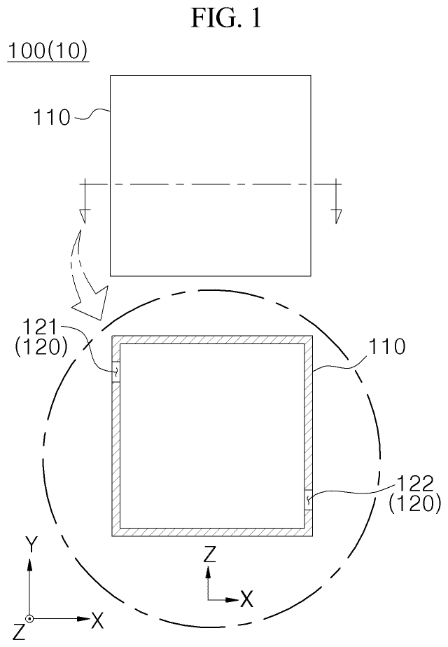

Hereinafter, the present disclosure will be described in detail through embodiments with reference to FIGS. 1 to 10. However, the embodiments are merely illustrative and the present disclosure is not limited to the specific embodiments described by way of example.

In this specification, an XYZ coordinate system may be used. For example, the XYZ coordinate system may correspond to a Cartesian coordinate system.

For example, the X-axis may represent a front-rear direction. For example, the negative X-axis direction may represent a forward direction. For example, the positive X-axis direction may represent a rearward direction. For example, the X-axis may correspond to a longitudinal direction of an electrode drying facility 10.

For example, the Y-axis may represent a left-right direction. For example, the negative Y-axis direction may represent a leftward direction. For example, the positive Y-axis direction may represent a rightward direction. For example, the Y-axis may correspond to a width direction of the electrode drying facility 10.

For example, the Z-axis may represent a vertical direction. For example, the negative Z-axis direction may represent a downward direction. For example, the positive Z-axis direction may represent an upward direction.

FIG. 1 is a view illustrating a chamber unit according to an embodiment of the present disclosure.

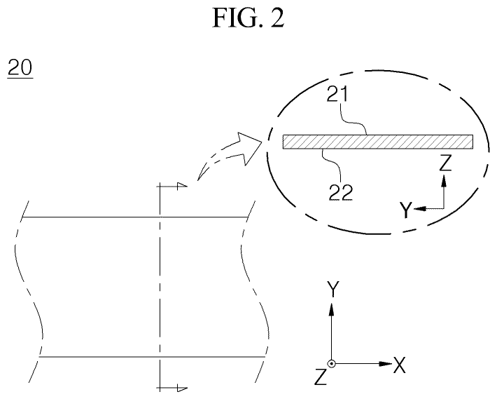

Referring to FIG. 1, the electrode drying facility 10 is a facility for drying and producing an electrode 20 (see FIG. 2), and may be referred to as a “facility for manufacturing electrodes.”

The electrode drying facility 10 may include a chamber unit 100. The chamber unit 100 may include a chamber body 110. The chamber body 110 may be rigid.

The chamber body 110 may define an internal space. For example, an inner surface of the chamber body 110 may face the space of the chamber body 110. For example, an outer surface of the chamber body 110 may be formed opposite the inner surface of the chamber body 110.

The chamber unit 100 may include a chamber slit 120. The chamber slit 120 may be an opening or slit formed in the chamber body 110. For example, the chamber slit 120 may penetrate through the chamber body 110. For example, the chamber slit 120 may connect the inner and outer surfaces of the chamber body 110.

A plurality of chamber slits 120 may be provided. For example, the chamber unit 100 may include an inlet slit 121 and an outlet slit 122. The chamber slit 120 may include or represent at least one of the inlet slit 121 and the outlet slit 122.

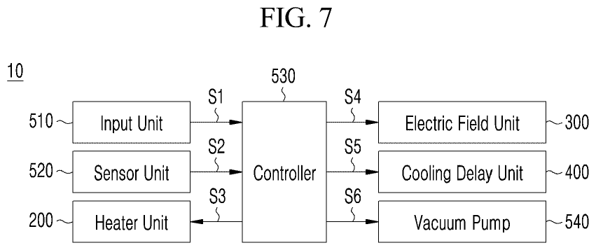

The internal pressure of the chamber unit 100 may be maintained lower than the external pressure of the chamber unit 100. For example, the chamber unit 100 may be connected to a vacuum pump 540 (see FIG. 7).

FIG. 2 is a view illustrating an electrode being introduced into an electrode drying facility.

Referring to FIG. 2, the electrode 20 may have a shape extending in a single direction. For example, the electrode 20 may be unwound from a wound state to form an extended shape.

The electrode 20 may have two sides. For example, a first electrode surface 21 may correspond to one side of the electrode 20. For example, a second electrode surface 22 may correspond to the opposite side of the electrode 20. The thickness of the electrode 20 may correspond to the distance between the first electrode surface 21 and the second electrode surface 22.

The electrode 20 may include a metal thin film (not shown) and a coating layer (not shown) applied to the metal thin film (not shown). The coating layer (not shown) may include an active material (not shown).

The active material (not shown) may contain moisture when applied to the metal thin film (not shown). Moisture contained in the active material (not shown) may adversely affect the performance of the electrode 20.

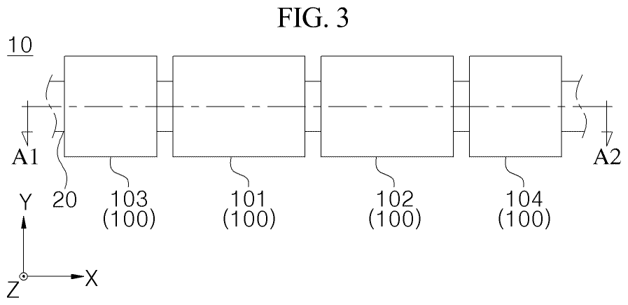

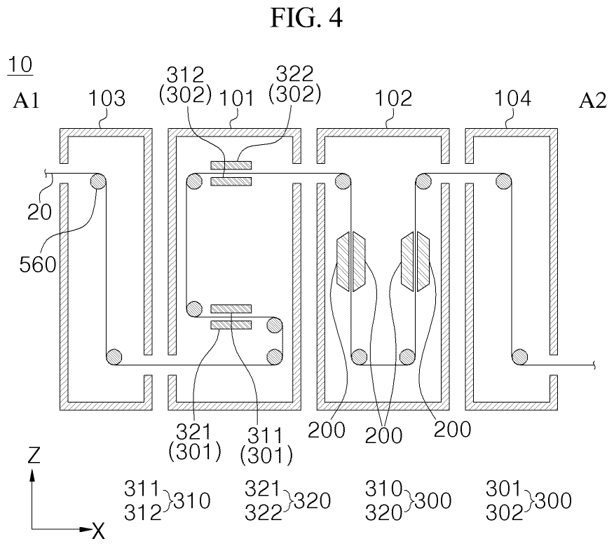

FIG. 3 is a view illustrating an electrode drying facility according to an embodiment of the present disclosure. FIG. 4 is a cross-sectional view of the electrode drying facility shown in FIG. 3, taken along line A1-A2.

Referring to FIGS. 3 and 4, a plurality of chamber units 100 may be provided. For example, the electrode drying facility 10 may include a plurality of chamber units 100. For example, the electrode drying facility 10 may include at least one of a first chamber 101, a second chamber 102, a pre-chamber 103 and a post-chamber 104. The chamber unit 100 may include or represent at least one of the first chamber 101, the second chamber 102, the pre-chamber 103 and the post-chamber 104.

The plurality of chamber units 100 may be arranged in sequence. For example, the pre-chamber 103, the first chamber 101, the second chamber 102, and the post-chamber 104 may be arranged in sequence.

The electrode 20 may be introduced into and discharged from the chamber unit 100. For example, the electrode 20 may be introduced into and discharged from the pre-chamber 103. For example, the electrode 20 may be introduced into the pre-chamber 103 through the inlet slit 121 (see FIG. 1), transferred within the pre-chamber 103, and then discharged through the outlet slit 122 (see FIG. 1).

For example, the electrode 20 discharged from the pre-chamber 103 through the outlet slit 122 (see FIG. 1) may be introduced into the first chamber 101 through the inlet slit 121 (see FIG. 1), transferred within the first chamber 101, and then discharged through the outlet slit 122 (see FIG. 1).

For example, the electrode 20 discharged from the first chamber 101 through the outlet slit 122 (see FIG. 1) may be introduced into the second chamber 102 through the inlet slit 121 (see FIG. 1), transferred within the second chamber 102, and then discharged through the outlet slit 122 (see FIG. 1).

For example, the electrode 20 discharged from the second chamber 102 through the outlet slit 122 (see FIG. 1) may be introduced into the post-chamber 104 through the inlet slit 121 (see FIG. 1), transferred within the post-chamber 104, and then discharged from the outlet slit 122 (see FIG. 1).

The electrode drying facility 10 may include a transfer roller assembly 560. The transfer roller assembly 560 may include a plurality of rollers 560. The transfer roller assembly 560 may transfer the electrode 20.

The electrode drying facility 10 may include an electric field unit 300. The electric field unit 300 may be located inside the chamber unit 100. For example, the electric field unit 300 may be located inside the first chamber 101.

The electric field unit 300 may apply an electric field to the electrode 20. For example, the electric field unit 300 may apply an electric field to the electrode 20 positioned inside the first chamber 101.

A plurality of electric field units 300 may be provided. For example, the electrode drying facility 10 may include a first electric field module 301 and a second electric field module 302. The electric field unit 300 may include or represent at least one of the first electric field module 301 and the second electric field module 302.

The electric field unit 300 may include a positive potential plate 310. The positive potential plate 310 may face one side of the electrode 20. The electric field unit 300 may also include a negative potential plate 320. The negative potential plate 320 may face the opposite side of the electrode 20.

Specifically, the positive potential plate 310 may include a first positive potential plate 311 facing one side of the electrode 20 in the first electric field module 301 and a second positive potential plate 312 facing one side of the electrode 20 in the second electric field module 302, and the negative potential plate 320 may include a first negative potential plate 321 facing the opposite side of the electrode 20 in the first electric field module 301 and a second negative potential plate 322 facing the opposite side of the electrode 20 in the second electric field module 302.

For example, the positive potential plate 310 and the negative potential plate 320 may be disposed with the electrode 20 interposed therebetween. For example, the first electrode surface 21 (see FIG. 2) may face the negative potential plate 320, and the second electrode surface 22 (see FIG. 2) may face the positive potential plate 310.

The electric potential of the positive potential plate 310 may differ from that of the negative potential plate 320. For example, the electric potential of the positive potential plate 310 may be greater than that of the negative potential plate 320.

An electric field may be formed between the positive potential plate 310 and the negative potential plate 320. For example, an electric field in the thickness direction of the electrode 20 may be applied to the electrode 20.

The intensity of the electric field generated by the first electric field module 301 may differ from that of the electric field generated by the second electric field module 302. For example, the intensity of the electric field generated by the second electric field module 302 may be greater than that of the electric field generated by the first electric field module 301.

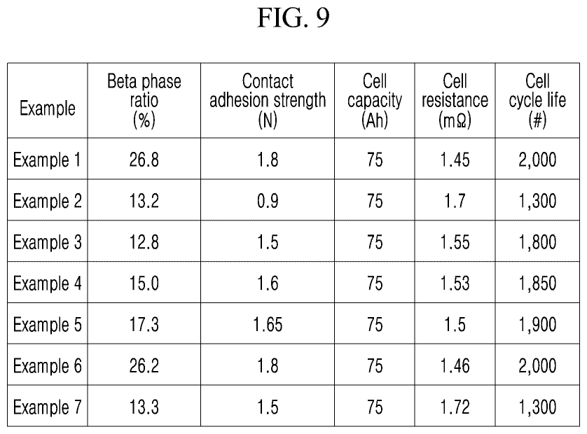

For example, as the electrode 20 is positioned in the electric field generated by the first electric field module 301, the beta phase ratio (see FIG. 9) of the electrode 20 may increase. For example, as the electrode 20 is positioned in the electric field generated by the second electric field module 302, the beta phase ratio (see FIG. 9) of the electrode 20 may increase.

The electrode drying facility 10 may include heater units 200. The heater units 200 may be located inside the chamber unit 100. For example, the heater units 200 may be located inside the second chamber 102.

The heater unit 200 may provide heat to the electrode 20. For example, the heater unit 200 may irradiate the electrode 20 with infrared rays. In another example, the heater unit 200 may apply high-temperature gas to the electrode 20. That is, the high-temperature gas supplied by the heater unit 200 may provide heat to the electrode 20.

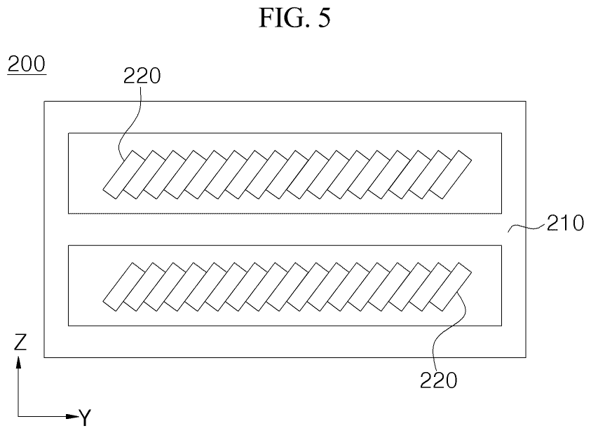

FIG. 5 is a view illustrating the heater unit shown in FIG. 4.

Referring to FIG. 5, the heater unit 200 may include a heater body 210. The heater body 210 may be coupled to or fixed to the chamber body 110 (see FIG. 1). For example, the heater body 210 may be coupled to or fixed to the chamber body 110 (see FIG. 1) of the second chamber 102 (see FIG. 4).

The heater unit 200 may include a heater segment 220. The heater segment 220 may include at least one of a heating wire and a laser cell.

The heater segment 220 may be coupled to or fixed to the heater body 210. The heater segment 220 may irradiate the electrode 20 (see FIG. 4) with infrared light while facing the electrode 20 (see FIG. 4).

A plurality of heater segments 220 may be provided. For example, the plurality of heater segments 220 may be arranged in a single direction. For example, the plurality of heater segments 220 may be arranged in the width direction of the electrode 20 (see FIG. 2).

The plurality of heater segments 220 may be individually controlled. For example, the output of each of the plurality of heater segments 220 may be individually controlled. For example, the intensity of infrared rays generated from each of the plurality of heater segments 220 may be independently adjusted.

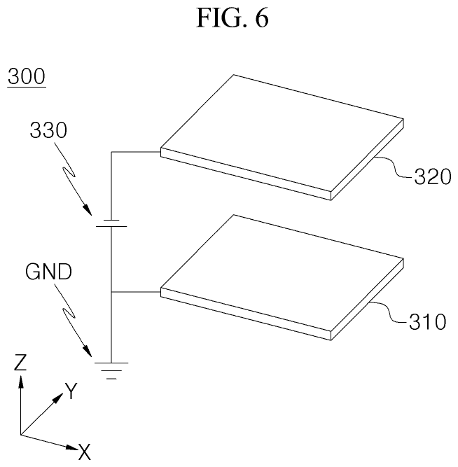

FIG. 6 is a view schematically illustrating the electric field unit shown in FIG. 4.

Referring to FIG. 6, the electric field unit 300 may include the positive potential plate 310, the negative potential plate 320, and a voltage source 330. The positive potential plate 310 and the negative potential plate 320 may be formed of metal.

The positive potential plate 310, the voltage source 330, and the negative potential plate 320 may be connected in sequence. The voltage source 330 may be electrically connected to ground GND.

For example, the positive potential plate 310, the voltage source 330, and the negative potential plate 320 may be electrically connected in sequence. For example, the potential of the positive potential plate 310 may be greater than that of the negative potential plate 320.

The positive potential plate 310 and the negative potential plate 320 may be disposed to face each other. An electric field may be formed between the positive potential plate 310 and the negative potential plate 320 due to a potential difference between the positive potential plate 310 and the negative potential plate 320.

The direction of the electric field generated between the positive potential plate 310 and the negative potential plate 320 may be from the positive potential plate 310 to the negative potential plate 320.

FIG. 7 is a block diagram of the electrode drying facility according to an embodiment of the present disclosure.

Referring to FIGS. 1 to 7, the electrode drying facility 10 may include an input unit 510. The input unit 510 may obtain input from a user or the like. The input unit 510 may generate a first signal S1.

The first signal S1 may include information regarding the input obtained by the input unit 510. For example, the first signal S1 may include command information related to operations of the electric field unit 300, the heater unit 200, a cooling delay unit 400, the vacuum pump 540, and the transfer roller assembly 560.

The electrode drying facility 10 may include a sensor unit 520. The sensor unit 520 may measure temperature. For example, the sensor unit 520 may measure the temperature of the electrode 20. For example, the sensor unit 520 may measure the internal temperature of the chamber unit 100.

The sensor unit 520 may measure electric field intensity. For example, the sensor unit 520 may measure the electric field intensity generated by the electric field unit 300.

The sensor unit 520 may measure pressure. For example, the sensor unit 520 may measure the internal pressure of the chamber unit 100. For example, the sensor unit 520 may include a pressure gauge.

The sensor unit 520 may generate a second signal S2. The second signal S2 may include information regarding at least one of the temperature, electric field intensity, and pressure measured by the sensor unit 520.

The electrode drying facility 10 may include a controller 530. The controller 530 may perform computations. The controller 530 may transmit and receive signals. For example, the controller 530 may be implemented using at least one of a processor, a CPU, a GPU, and a circuit board.

The controller 530 may generate output signals S3, S4, S5 and S6 based on input signals S1 and S2. The input signals S1 and S2 may include or represent at least one of the first signal S1 and the second signal S2. The output signals S3, S4, S5 and S6 may include or represent at least one of a third signal S3, a fourth signal S4, a fifth signal S5 and a sixth signal S6.

The heater unit 200 may receive the third signal S3 from the controller 530. The heater unit 200 may operate according to the third signal S3. For example, each of the plurality of heater segments 220 of the heater unit 200 may operate individually according to the third signal S3.

The electric field unit 300 may receive the fourth signal S4 from the controller 530. The electric field unit 300 may operate according to the fourth signal S4. For example, the voltage generated by the voltage source 330 may vary depending on the fourth signal S4.

In another example, the distance between the positive potential plate 310 and the negative potential plate 320 may be adjusted. For example, the distance between the positive potential plate 310 and the negative potential plate 320 may vary depending on the fourth signal S4.

The electrode drying facility 10 may include the cooling delay unit 400. The cooling delay unit 400 may be located inside the chamber unit 100. For example, the cooling delay unit 400 may be located inside the post-chamber 104.

The cooling delay unit 400 may control the internal temperature of the post-chamber 104. For example, the internal temperature of the post-chamber 104 may be maintained, by the cooling delay unit 400, at a level between the internal temperature of the second chamber 102 and the external temperature of the electrode drying facility 10.

For example, the cooling delay unit 400 may supply intermediate-temperature gas to the electrode 20 positioned in transit through the post-chamber 104. The temperature of the intermediate-temperature gas may be lower than that of the high-temperature gas. For example, the electrode 20 discharged from the second chamber 102 may be cooled more gradually.

The cooling delay unit 400 may receive the fifth signal S5 from the controller 530. The fifth signal S5 may include setting information regarding the internal temperature of the post-chamber 104. The cooling delay unit 400 may operate according to the fifth signal S5.

The electrode drying facility 10 may include the vacuum pump 540. The vacuum pump 540 may be connected to or coupled with the chamber unit 100. For example, the vacuum pump 540 may maintain the internal pressure of the chamber unit 100 below atmospheric pressure. For example, the vacuum pump 540 may draw in gas (or air) located inside the chamber unit 100.

The vacuum pump 540 may receive the sixth signal S6 from the controller 530. For example, the vacuum pump 540 may operate according to the sixth signal S6. The sixth signal S6 may include setting information regarding the internal pressure of each of the pre-chamber 103, the first chamber 101, the second chamber 102 and the post-chamber 104.

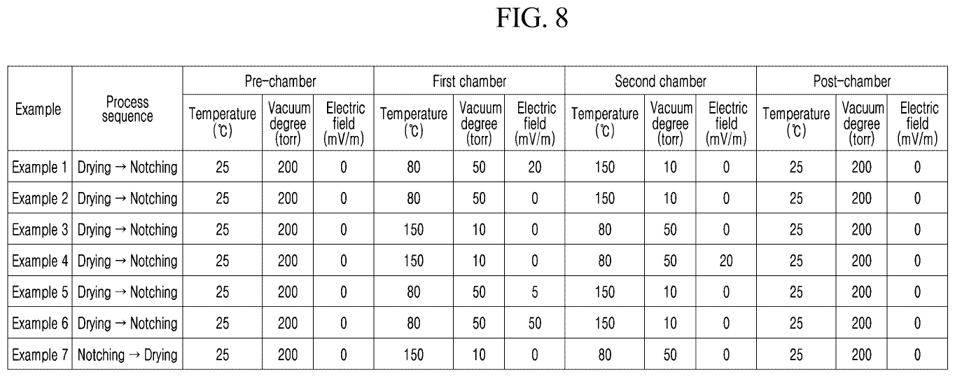

FIG. 8 is a table illustrating examples having different internal settings and process sequences of a plurality of chamber units. FIG. 9 is a table illustrating the characteristics of electrodes and battery cells manufactured according to each example shown in FIG. 8.

Referring to FIGS. 1 to 9, according to Examples 1 to 6, the electrode 20 may be notched after being dried. According to Example 7, the electrode 20 may be dried after being notched.

According to Examples 1 to 7, the internal temperature of the pre-chamber 103 may be 25 [° C.] as room temperature, the internal vacuum degree of the pre-chamber 103 may be 200 [torr], and no electric field may be applied to the electrode 20 positioned in transit through the pre-chamber 103.

According to Examples 1, 2, 5 and 6, the internal temperature of the first chamber 101 may be 80 [° C.]. According to Examples 3, 4 and 7, the internal temperature of the first chamber 101 may be 150 [° C.].

According to Examples 1, 2, 5 and 6, the vacuum degree of the first chamber 101 may be 50 [torr]. According to Examples 3, 4 and 7, the vacuum degree of the first chamber 101 may be 10 [torr].

According to Example 1, the intensity of the electric field generated by the electric field unit 300 located inside the first chamber 101 may be 20 [mV/m]. According to Example 5, the intensity of the electric field generated by the electric field unit 300 located inside the first chamber 101 may be 5 [mV/m]. According to Example 6, the intensity of the electric field generated by the electric field unit 300 located inside the first chamber 101 may be 50 [mV/m]. According to Examples 2, 3, 4, and 7, no electric field may be applied to the electrode 20 positioned in transit through the first chamber 101.

According to Examples 1, 2, 5 and 6, the internal temperature of the second chamber 102 may be 150 [° C.], and the internal vacuum degree of the second chamber 102 may be 10 [torr]. According to Examples 3, 4 and 7, the internal temperature of the second chamber 102 may be 80 [° C.], and the internal vacuum degree of the second chamber 102 may be 50 [torr].

According to Examples 1, 2, 3, 5, 6 and 7, no electric field may be applied to the electrode 20 positioned in transit through the second chamber 102. According to Example 4, the intensity of the electric field generated by the electric field unit 300 located inside the second chamber 102 may be 20 [mV/m].

The environment of the post-chamber 104 may be the same as that of the pre-chamber 103. For example, according to Examples 1 to 7, the internal temperature of the post-chamber 104 may be 25 [° C.] as room temperature, the internal vacuum degree of the post-chamber 104 may be 200 [torr], and no electric field may be applied to the electrode 20 positioned in transit through the post-chamber 104.

Examples 3 and 7 may be compared. When comparing the process conditions of Example 3 with those of Example 7, the conditions may be the same except for the sequence of the drying process and the notching process.

The cycle life of a battery cell may be evaluated based on the number of charge and discharge cycles of the battery cell. A higher number of charge and discharge cycles may indicate a longer cycle life of the battery cell.

The cycle life of a battery cell including the electrode 20 according to Example 3 is 1800 [cycles], while the cycle life of a battery cell including the electrode 20 according to Example 7 is 1300 [cycles].

Therefore, the process sequence in which the electrode 20 is notched after being dried may be more effective than the process sequence in which the electrode 20 is dried after being notched.

Examples 2 and 3 may be compared. The conditions of the first chamber 101 and the second chamber 102 according to Example 2 may be the same as those of the second chamber 102 and the first chamber 101 according to Example 3.

For example, the internal temperature of the first chamber 101 is 80 [° C.] in Example 2 and 150 [° C.] in Example 3. The internal vacuum degree of the first chamber 101 is 50 [torr] in Example 2 and 10 [torr] in Example 3.

For example, the internal temperature of the second chamber 102 is 150 [° C.] in Example 2 and 80 [° C.] in Example 3. The internal vacuum degree of the second chamber 102 is 10 [torr] in Example 2 and 50 [torr] in Example 3.

The cycle life of a battery cell including the electrode 20 according to Example 2 is 1300 [cycles], while the cycle life of a battery cell including the electrode 20 according to Example 3 is 1800 [cycles].

Therefore, the process according to Example 2, in which the temperature of the electrode 20 is increased and then cooled relatively gradually, may be more effective than the process according to Example 3, in which the temperature of the electrode 20 is increased and then cooled relatively rapidly.

Examples 1 and 2 may be compared. The processes according to Example 1 and Example 2 may be the same, except for whether or not the electric field unit 300 located in the first chamber 101 applies an electric field to the electrode 20.

That is, in the process according to Example 1, an electric field of 20 [mV/m] may be applied to the electrode 20, whereas in the process according to Example 2, no electric field may be applied to the electrode 20.

The cycle life of a battery cell including the electrode 20 according to Example 1 may be 2000 [cycles], whereas the cycle life of a battery cell including the electrode 20 according to Example 2 may be 1300 [cycles].

The coating layer (not shown) included in the electrode 20 may include polyvinylidene fluoride (PVDF). For example, the binder (not shown) included in the electrode 20 may include PVDF. The beta phase ratio of the PVDF included in the electrode 20 may be expressed as a percentage. The beta phase ratio of the PVDF included in the electrode 20 may be measured by irradiating the electrode 20 with X-rays.

Looking at the beta phase ratio of the electrode 20, the beta phase ratio of the electrode 20 according to Example 2 is 13.2 [%], while the beta phase ratio of the electrode 20 according to Example 1 is 26.8 [%].

For example, if the beta phase ratios of the electrode 20 are different under the same conditions, it can be inferred that the beta phase ratio of the electrode 20 affects the cycle life of the battery cell. That is, it can be seen that the beta phase ratio of the electrode 20 and the cycle life of the battery cell exhibit a positive correlation.

Therefore, the electric field applied to the electrode 20 may improve the quality of a battery cell including electrode 20. For example, the electric field applied to the electrode 20 during heating of the electrode 20 may effectively improve the quality of the battery cell including electrode 20.

Examples 2 and 3 may be compared. The process conditions of the first chamber 101 and the second chamber 102 in Example 2 may be the same as those of the first chamber 101 and the second chamber 102 in Example 3.

For example, in Example 2, the electrode 20 may be heated relatively gradually and cooled relatively rapidly. In contrast, in Example 3, the electrode 20 may be heated relatively rapidly and cooled relatively gradually.

The cycle life of a battery cell including the electrode 20 according to Example 2 may be 1300 [cycles], and the cycle life of a battery cell including the electrode 20 according to Example 3 may be 1800 [cycles].

The beta phase ratio of the electrode 20 according to Example 2 is 13.2 [%], and the beta phase ratio of the electrode 20 according to Example 3 is 12.8 [%]. Therefore, the influence of the difference in the heating and cooling rates of the electrode 20 on the variation in the beta phase ratio may be relatively small.

The difference in the heating and cooling rates of the electrode 20 may affect the characteristics of the foil of the metal material included in the electrode 20. That is, a process of heating the electrode 20 more rapidly and cooling it more gradually may be relatively advantageous for improving the quality of the electrode 20.

Examples 1, 2, 5 and 6 may be compared. The process conditions of Examples 1, 2, 5 and 6 may be the same, except for the magnitude of the electric field applied to the electrode 20 positioned in transit through the first chamber 101.

Comparing Examples 2 and 5, the cycle life of the battery cell according to Example 5, in which the intensity of the electric field applied to the electrode 20 is 5 [mV/m], is 1900 [cycles], whereas the cycle life of the battery cell according to Example 2, in which the intensity of the electric field applied to the electrode 20 is 0 [mV/m], is 1300 [cycles]. That is, the electric field applied to the electrode 20 may affect the beta phase ratio, thereby increasing the cycle life of the battery cell.

Comparing Examples 1 and 6, the cycle life of the battery cell according to Example 1, in which the intensity of the electric field applied to the electrode 20 is 20 [mV/m], is 2000 [cycles] and the beta phase ratio of the electrode 20 is 26.8 [%], and the cycle life of the battery cell according to Example 6, in which the intensity of the electric field applied to the electrode 20 is 50 [mV/m], is 2000 [cycles] and the beta phase ratio of the electrode 20 is 26.2 [%].

Comparing Examples 1, 2, 5 and 6, when the intensity of the electric field applied to the electrode 20 is 5 [mV/m] to 20 [mV/m], the beta phase ratio of the electrode 20 may effectively increase, thereby effectively improving the cycle life of the battery cell.

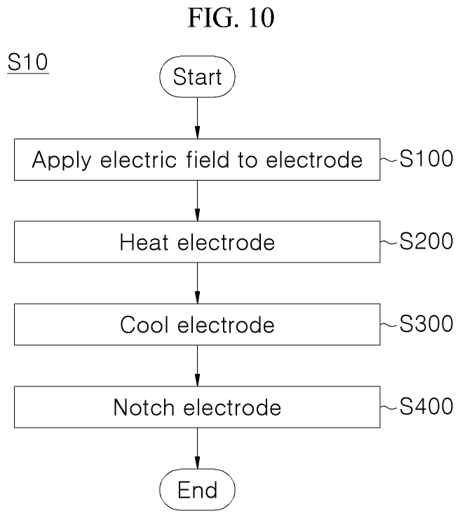

FIG. 10 is a flowchart illustrating a method for manufacturing electrodes, also referred to as an electrode manufacturing method, according to an embodiment of the present disclosure.

Referring to FIGS. 1 to 10, the electrode manufacturing method (S10) may include electrode drying steps (S100, S200 and S300). In steps S100, S200 and S300, the electrode drying facility 10 may dry the electrode 20.

The electrode drying steps (S100, S200 and S300) may include a step (S100) of applying an electric field to the electrode 20. In step S100, the electric field unit 300 may apply an electric field to the electrode 20 inside the first chamber 101. The internal pressure of the first chamber 101 may be lower than the external pressure of the first chamber 101.

In step S100, the electric field unit 300 may apply an electric field to the electrode 20 in two stages. For example, the first electric field module 301 may apply an electric field having a first electric field intensity to the electrode 20.

For example, the second electric field module 302 may apply an electric field having a second electric field intensity to the electrode 20. The second electric field intensity may differ from the first electric field intensity. For example, the second electric field intensity may be greater than the first electric field intensity.

For example, the intensity range of the first electric field may be distinguished from that of the second electric field. For example, the intensity ranges of the first electric field and the second electric field may be distinguished within the range of 5 [mV/m] to 20 [mV/m].

For example, the first electric field module 301 may apply an electric field having an intensity of 5 [mV/m] to 10 [mV/m] to the electrode 20, and the second electric field module 302 may apply an electric field having an intensity of 15 [mV/m] to 20 [mV/m] to the electrode 20.

The electrode drying steps (S100, S200 and S300) may include a step (S200) of heating the electrode 20. In step S200, the heater unit 200 may provide heat to the electrode 20 inside the second chamber 102.

The internal temperature of the first chamber 101 may be higher than that of the pre-chamber 103 and lower than that of the second chamber 102. The internal pressure of the first chamber 101 may be lower than that of the pre-chamber 103 and higher than that of the second chamber 102.

The electrode drying steps (S100, S200 and S300) may include a step (S300) of cooling the electrode 20. In step S300, the electrode 20 may be cooled in the post-chamber 104. In step S300, the cooling delay unit 400 may slow down the cooling rate of the electrode 20.

The electrode manufacturing method (S10) may include a step (S400) of notching the electrode 20. In step S400, the electrode 20 may be notched. The notched electrode 20 may form a battery cell.

The electrode drying facility 10 may include the first chamber 101 and the second chamber 102, each defining a hollow portion therein and arranged side by side. The electrode drying facility 10 may include the electric field unit 300, at least a portion of which is located inside the first chamber 101 and generates an electric field. The electrode drying facility 10 may include the heater unit 200, at least a portion of which is located inside the second chamber 102.

The internal pressure of the first chamber 101 may be greater than that of the second chamber 102. The internal temperature of the second chamber 102 may be higher than that of the first chamber 101.

The electric field unit 300 may include the positive potential plate 310 and the negative potential plate 320 spaced apart while facing each other. The electric field unit 300 may include the voltage source 330 that electrically connects the positive potential plate 310 and the negative potential plate 320.

The electric potential of the positive potential plate 310 may be higher than that of the negative potential plate 320.

The electrode drying facility 10 may include the pre-chamber 103 defining a hollow portion therein and disposed adjacent to the first chamber 101. The electrode drying facility 10 may include the post-chamber 104 defining a hollow portion therein and disposed adjacent to the second chamber 102. The pre-chamber 103, the first chamber 101, the second chamber 102, and the post-chamber 104 may be arranged in sequence.

The internal pressures of the pre-chamber 103 and the post-chamber 104 may be greater than those of the first chamber 101 and the second chamber 102. The internal temperatures of the pre-chamber 103 and the post-chamber 104 may be lower than those of the first chamber 101 and the second chamber 102.

The intensity of the electric field generated by the electric field unit 300 may be 5 [mV/m] to 20 [mV/m].

The electrode drying facility 10 may include the first chamber 101 defining a hollow portion therein and through which the electrode 20 is introduced and discharged. The electrode drying facility 10 may include the second chamber 102 defining a hollow portion therein and into which the electrode 20 discharged from the first chamber 101 is introduced. The electrode drying facility 10 may include the electric field unit 300, at least a portion of which is located inside the first chamber 101 and is configured to apply an electric field to the electrode 20. The electrode drying facility 10 may include the heater unit 200, at least a portion of which is located inside the second chamber 102 and is configured to apply heat to the electrode 20.

The electric field unit 300 may include the positive potential plate 310 facing one side of the electrode 20 and the negative potential plate 320 facing the opposite side of the electrode 20. The potential of the positive potential plate 310 may be higher than that of the negative potential plate 320.

The electrode 20 may be introduced into the pre-chamber 103 and discharged from the pre-chamber 103. The electrode 20 discharged from the pre-chamber 103 may be introduced into the first chamber 101. The electrode 20 discharged from the second chamber 102 may be introduced into the post-chamber 104.

The electrode manufacturing method (S10) may include the step (S100) of applying an electric field to the electrode 20. The electrode manufacturing method (S10) may include the step (S200) of heating the electrode 20. The electrode manufacturing method (S10) may include the step (S400) of notching the electrode 20.

The step (S100) of applying an electric field to the electrode 20 may include the steps of applying an electric field having a first electric field intensity to the electrode 20 and applying an electric field having a second electric field intensity to the electrode 20.

The intensity of the second electric field may be greater than that of the first electric field. For example, the intensity of the first electric field may be 5 [mV/m] to 10 [mV/m], and the intensity of the second electric field may be 10 [mV/m] to 20 [mV/m].

In step S100 of applying an electric field to the electrode 20, the electrode 20 may be positioned in transit through the first chamber 101. In step S200 of heating the electrode 20, the electrode 20 may be positioned in transit through the second chamber 102. The internal pressure of the first chamber 101 may be greater than that of the second chamber 102. The internal temperature of the second chamber 102 may be greater than that of the first chamber 101.

The contents described above are merely examples of applying the principles of the present disclosure, and other configurations may be further included without departing from the scope of the present disclosure.

What is claimed is:

1. A facility for drying electrodes comprising:
a first chamber and a second chamber, each defining a hollow portion therein and arranged side by side;
an electric field unit, at least a portion of which is located inside the first chamber and configured to generate an electric field; and
a heater unit, at least a portion of which is located inside the second chamber.

2. The facility for drying electrodes according to claim 1, wherein an internal pressure of the first chamber is greater than that of the second chamber, and
an internal temperature of the second chamber is higher than that of the first chamber.

3. The facility for drying electrodes according to claim 1, wherein the electric field unit comprises:
a positive potential plate and a negative potential plate spaced apart while facing each other; and
a voltage source that electrically connects the positive potential plate and the negative potential plate.

4. The facility for drying electrodes according to claim 3, wherein a potential of the positive potential plate is higher than that of the negative potential plate.

5. The facility for drying electrodes according to claim 1, further comprising:
a pre-chamber defining a hollow portion therein and disposed adjacent to the first chamber; and
a post-chamber defining a hollow portion therein and disposed adjacent to the second chamber,
wherein the pre-chamber, the first chamber, the second chamber and the post-chamber are arranged in sequence.

6. The facility for drying electrodes according to claim 5, wherein the internal pressures of the pre-chamber and the post-chamber are greater than those of the first chamber and the second chamber, and
the internal temperature of the pre-chamber and the post-chamber are lower than those of the first chamber and the second chamber.

7. The facility for drying electrodes according to claim 1, wherein the intensity of the electric field is 5 [mV/m] to 20 [mV/m].

8. A facility for drying electrodes comprising:
a first chamber defining a hollow portion therein and through which the electrode is introduced and discharged;
a second chamber defining a hollow portion therein and into which the electrode discharged from the first chamber is introduced;
an electric field unit, at least a portion of which is located inside the first chamber and configured to apply an electric field to the electrode; and
a heater unit, at least a portion of which is located inside the second chamber and configured to apply heat to the electrode.

9. The facility for drying electrodes according to claim 8, wherein the intensity of the electric field is 5 [mV/m] to 20 [mV/m].

10. The facility for drying electrodes according to claim 8, wherein an internal pressure of the first chamber is greater than that of the second chamber, and
an internal temperature of the second chamber is higher than that of the first chamber.

11. The facility for drying electrodes according to claim 8, wherein the electric field unit comprises:
a positive potential plate facing one side of the electrode; and
a negative potential plate facing the opposite side of the electrode,
wherein a potential of the positive potential plate is higher than that of the negative potential plate.

12. The facility for drying electrodes according to claim 8, further comprising:
a pre-chamber defining a hollow portion therein and disposed adjacent to the first chamber; and
a post-chamber defining a hollow portion therein and disposed adjacent to the second chamber,
wherein the pre-chamber, the first chamber, the second chamber and the post-chamber are arranged in sequence.

13. The facility for drying electrodes according to claim 12, wherein the electrode is introduced into the pre-chamber and discharged from the pre-chamber,
the electrode discharged from the pre-chamber is introduced into the first chamber,
the electrode discharged from the first chamber is introduced into the second chamber, and
the electrode discharged from the second chamber is introduced into the post-chamber.

14. The facility for drying electrodes according to claim 13, wherein the internal pressures of the pre-chamber and the post-chamber are greater than those of the first chamber and the second chamber, and
the internal temperatures of the pre-chamber and the post-chamber are lower than those of the first chamber and the second chamber.

15. A method for manufacturing electrodes comprising the steps of:
applying an electric field to the electrode;
heating the electrode; and
notching the electrode.

16. The method for manufacturing electrodes according to claim 15, wherein the step of applying an electric field to the electrode comprises:
applying an electric field having a first electric field intensity to the electrode; and applying an electric field having a second electric field intensity to the electrode.

17. The method for manufacturing electrodes according to claim 16, wherein the second electric field intensity is greater than the first electric field intensity.

18. The method for manufacturing electrodes according to claim 16, wherein the first electric field intensity is 5 [mV/m] to 10 [mV/m], and
the second electric field intensity is 15 [mV/m] to 20 [mV/m].

19. The method for manufacturing electrodes according to claim 15, wherein, in the step of applying an electric field to the electrode, the electrode is positioned in transit through a first chamber, and
in the step of heating the electrode, the electrode is positioned in transit through a second chamber,
wherein an internal pressure of the first chamber is greater than that of the second chamber, and
an internal temperature of the second chamber is higher than that of the first chamber.

20. The method for manufacturing electrodes according to claim 15, wherein in the step of applying an electric field to the electrode, the intensity of the electric field applied to the electrode is 5 [mV/m] to 20 [mV/m].
